(19) United States
(12) Patent Application Publication
(10) Pub. No.: US 2017/0251732 A1
(43) Pub. Date: Sep. 7, 2017

(54) SEAM TAPES INCLUDING FIBER BASED CIRCUITRY

(71) Applicant: Noble BioMaterials, Inc., Scranton, PA (US)

(72) Inventor: Joel Furey, Concord, MA (US)

(21) Appl. No.: 15/448,275

(22) Filed: Mar. 2, 2017

Related U.S. Application Data
(60) Provisional application No. 62/302,444, filed on Mar. 2, 2016.

(51) Int. Cl. A41D 1/00; H01B 1/02; A41D 27/24; B32B 7/12; B32B 5/02

(52) U.S. Cl. CPC A41D 1/005; B32B 7/12; B32B 5/02; A41D 27/245; H01B 1/02; B32B 2437/00; B32B 2307/202; A41D 2300/52

(57) ABSTRACT

Systems and methods which make use of metalized fabrics and threads as wiring by attaching them to clothing as a part of a seam tape. The attachment may occur at the seam through a seam tape which is already being used with the garment, or it may occur by attaching the seam tape to a seam, or simply a surface of the garment, to position the wiring in the desired location.

### CROSS REFERENCE TO RELATED APPLICATION(S)

This application claims the benefit of U.S. Provisional Patent Application Ser. No. 62/302,444, filed Mar. 2, 2016, the entire disclosure of which is herein incorporated by reference.

### BACKGROUND

1. Field of the Invention

This disclosure is related to the field of metalized fibers, threads, and yarns. Particularly to systems and methods for using such metalized structures as circuitry in clothing by placing within a seam tape.

2. Description of the Related Art

Fabrics and clothing, while known to be constructed of natural or synthetic fibers, are becoming increasingly metallic. In addition to the metallization of fabrics and threads for antimicrobial purposes in everything from medical supplies to odor control, metallization of fabrics and threads is also gaining increased use in the textile industry for a variety of other purposes. One of the most major of these is interconnected or “smart” clothing which includes sensors and other devices. In these articles of clothing, sensors are built into the clothing, or attached to leads in the clothing, to monitor everything from heart rate, breathing, and composition of sweat, to a variety of other factors.

While these “smart” articles have primarily seen use in fitness, exercise, and athletic performance attire, they are adaptable to a wide variety of industries including health care, location, personal information, and safety. Because of the clothing's proximity to the wearer's skin through a large portion of a day, smart clothing provides an ability to inconspicuously monitor aspects of the human body on a continuous or near continuous basis that has not been available before.

Smart clothing will generally comprise one or more sensors which are capable of monitoring a particular aspect of the wearer's body. These can include chemical sensors, temperature sensors, movement sensors, and others. The inclusion of such sensors in clothing is leading to a need for data to be carried from the sensor to some kind of device to make the data useful for the wearer. Individuals can use this data to improve the effectiveness of their exercise, to detect potentially problematic situations (such as a pending heart attack), or even to make sure that they do not have too much body odor (or that they inadvertently applied too much perfume) before walking into an interview.

However, for the data to be useful, the user needs the sensor output to be interpreted by a processor or similar device and presented in an interpretable form. The transfer of data within the clothing, as well as the need to carry power from power generation devices, such as batteries, solar panels, or kinetic engines to the sensors, processors, and communication devices has led to clothing which now needs to be run through with wires to carry data signals and power between various elements of the system.

While wireless communication within clothing or from clothing to other devices such as smart phones or other mobile devices is one option, it requires each of the various components (e.g. each sensor) to have its own dedicated power source, antenna, and communication capability which can be bulky. This solution is logical for other wearables (such as fitness trackers) where the device is comfortably worn on the clothing, but usually doesn't work for devices that need are integrated with clothing. Thus, it is generally necessary, at least for the foreseeable future, to include wires in the clothing to communicate electricity, both in the form of data and power, between components of such “smart” systems.

This presents some problematic issues. In the first instance, the transfer has to be safe to the wearer. In most cases, this is not a major issue as the amount of power being communicated is small, and direct current (DC) is generally used which has little to no known effect on the human body, at least at a macro scale. While the electrical transfer will, thus, generally not dramatically affect the body of the wearer, the body of the wearer can affect the wiring in dramatic ways. The conductivity of surrounding fibers, the conductivity of human skin, the presence of liquids, such as, but not limited to, water or sweat in the clothing, and movement and flexing of the body can effect electrical properties of wiring in the clothing.

Further, when transferring electricity in clothing, the wires have generally needed to be quite small so as to not detrimentally affect the appearance of the clothing. While in certain kinds of clothing (such as athletic clothing), visible wiring would likely not be a big issue and in some types of clothing a metallic or even electrical appearance can be part of the style, in other types of clothing (such as business clothing) it can be flatly unacceptable from a style point of view.

In addition to a hostile environment chemically for small wires, wiring in clothing also has to deal with a relatively hostile physical environment. Many articles of clothing are designed to flex and move with the underlying body to allow the user to move freely (without being pinched or trapped by the clothing) and to effectively be able to move as if they were not actually wearing the clothing. This type of arrangement can be particularly desirable for smart clothing as it can help sensors to be maintained in a specific position relative to the wearer's body.

However, this type of arrangement requires the wires to be able to flex and bend with the clothing's fabric movement. Further, it also requires the wires to feel appropriate within the clothing and not provide an undesirable feel against the skin or in the movement of the clothing when the clothing moves. Still further, even in the most closely fitting garments, there is generally still relative movement against the skin of the wearer, and against other articles of clothing, which creates friction which can both damage the wires, and generate static electricity which can interfere with them.

Even in clothing which is not “skin tight” the flexibility of clothing can present issues for wiring. Wires which may be multiple inches apart when a piece of fabric is flat, can be brought into contact with each other if the clothing article, or parts of it, are moved relative to each other in certain ways. For example, a shirt may bunch up if the user moves into a position where their head is lower than their waist. Similarly, a portion of a sleeve may contact the torso of the clothing, or be far away from it depending on the position of the user's arm. Thus, electric properties of wires which utilize distance to provide electrical isolation are often not suitable in clothing.

Finally, on top of all the concerns when the clothing is being worn, clothing has an additional problem which is the need to be laundered. Regardless of its purpose, virtually every article of clothing eventually needs to be laundered in a liquid which is commonly water. However, dry cleaned products are also exposed to certain liquid chemicals such as, but not limited to, tetrachloroethylene (also known as perchloroethylene) or various petroleum based hydrocarbon solvents in their cleaning process. Even in water laundering, the laundry water will typically contain soaps, as well as stain removers (such as, but not limited to, chlorine bleach, hydrogen peroxide, and vinegar) and potentially other chemicals which are intended to be reactive. Without laundering, the exposure of clothing to the human body will rapidly render it unwearable through the growth of bacteria (which may cause odor), buildup of salts (which can stiffen it), and exposure to other undesirable materials which need to be removed (such as sulfur, dirt, food particles, or dead skin cells).

While there has been a recent influx of technology related to sensors for use in smart clothing and the technology for analyzing their output, the infrastructure is often ignored. The wiring of clothing is commonly done with the use of metal microwires, printing wiring patterns onto fabric substrates, or with metalized fibers or yarns made from the components of the fabric which can act as wires. These “wires” can be made separately and incorporated into a fabric during weaving, may be added to fabrics as a thread after manufacture, or can be formed as part of the fabric construction process. However, they are generally all visible and relatively susceptible to damage.

Much of the traditional need for metal to be included in fabrics has come from health care. A number of metals, most notably silver or related materials which act as a source for silver ions, can be effective non-specific antimicrobials. Because of this focus, in order to provide for metals in textiles, a textile thread or resultant textile product is commonly soaked in metal particles or otherwise coated with a thin film of metal. This film adheres to the thread or textile through a variety of forces such as electrostatics or by becoming wedged in small openings. While this is effective to get metal into the fabric and/or thread, it has a number of downsides. For example, coating a thread with metal will generally make a thread with a metallic appearance meaning that when the thread is sewn into a fabric, and then a clothing article, the thread will often be visible, even if it is very small.

A further problem with post-manufacture metal exposure is that, even through the use of advanced binders, the metal may be washed away by necessary fluid exposure (for example, it is generally the case that a swimsuit would be exposed to water when worn) or laundering. For example, fabric or yarn that has been impregnated with metal may have the metal particles simply held within spaces or channels of the fabric or yarn by friction. If the fabric or yarn is exposed to liquid, the liquid also competes to occupy the same space and channels and may knock the metal particles loose so that they free float in the liquid. This can disrupt the electrical properties of the metalized yarn or destroy it completely.

Because of problems due to loss of metallization when exposed to liquid, some threads are manufactured with metal particles placed directly into the material prior to thread formation. While this does not work for many natural threads unless the metal is spun into the thread with the fibers (and it is still generally held in place by friction), it can work for a variety of synthetic polymer threads such as polyester and Nylon™ where small particles of metal are added to the polymer melt from which the original filaments are extruded and then spun into filament bundles. This allows for the metal to actually be contained as a part of the thread itself (co-formed) which inhibits it from separating from the fabric made from the thread.

A concern with co-forming the metal into the fiber in a wiring application, however, is to make sure that there is enough metal present to provide sufficient electric qualities, while not having excess metal which may interfere with the formation of the synthetic thread. As metalized threads used to carry electricity or data will generally require a continuous or near continuous metal path through the thread, this forming process can be substantially more complicated than it is for medical antimicrobial metals where a more macro scale exposure to the metal is desired.

The general problem with the use of metalized threads as wiring is to make sure that they have a sufficient lifespan to make the clothing, which is reliant on their electrical properties, useable and that they continuously maintain their electrical properties regardless of what the clothing is doing. While metalized particles acting as an antimicrobial may simply become slightly less effective over time, or be intended for single use (such as in a bandage) this generally isn't the case for fibers which need to carry data or power signals. Particularly when it comes to data, loss of information can be problematic if wires carrying the data are not correctly shielded from the outside world, and each other, or suffer damage. In data, even a small amount of loss or attenuation, if it's consistent, can destroy functionality of the clothing.

The feel of fabrics is another issue which is often not readily definable, but effects an end user's decision to purchase or wear an article of clothing. Some of these issues are discussed in Woven Fabrics Chapter 9, “Sensorial Comfort of Textile Materials”, Kayseri et al. (2012). Chemicals are sometimes applied to fabrics to improve their feel which are desired to form a thin layer over the fabric or thread which alters the sensation of touching the thread. While this can improve feel, these coatings can interfere with desired properties of a metalized fabric and may actually be detrimental to their operating as they should.

### SUMMARY

Because of these and other problems in the art, described herein are systems and methods which make use of metalized fabrics and threads as wiring by attaching them to clothing as a part of a seam tape. The attachment may occur at the seam through a seam tape which is already being used with the garment, or it may occur by attaching the seam tape to a seam, or simply a surface of the garment, to position the wiring in the desired location.

There is described herein, among other things, a seam tape comprising: a top layer; an underlayment layer; an adhesive layer arranged between the top layer and the underlayment layer; and an electrically conductive wire, the wire being positioned within the adhesive layer and between the underlayment layer and the top layer; wherein, the seam tape is configured to bond to a fabric placed proximate the underlayment layer via adhesive in the adhesive layer.

In an embodiment of the seam tape, the wire comprises a metallic thread.

In an embodiment of the seam tape, the wire comprises a metallized fiber.

In an embodiment of the seam tape, the wire comprises an elongated strip of metalized fabric.

In an embodiment of the seam tape, the elongated strip includes ends with a larger per unit area than a connection between the ends.

In an embodiment of the seam tape, the top layer includes a hole therethrough so a portion of at least one of the ends is electrically accessible through the hole.

In an embodiment of the seam tape, the top layer includes a hole therethrough so a portion of the metalized fabric is electrically accessible through the hole.

In an embodiment of the seam tape, the adhesive is a thermosetting adhesive.

In an embodiment of the seam tape, the adhesive is a sonic bonding adhesive.

In an embodiment of the seam tape, the top layer is water resistant.

There is also described herein a seam tape comprising: a top layer; an adhesive layer arranged on the top layer; and an electrically conductive wire, the wire being positioned within the adhesive layer; wherein, the seam tape is configured to bond to a fabric placed proximate the adhesive layer via an adhesive in the adhesive layer.

There is also described herein an article of clothing comprising: fabric forming the clothing; and a seam tape including: a top layer; an adhesive layer arranged on the top layer; and an electrically conductive wire, the wire being positioned within the adhesive layer; wherein, the seam tape is bonded to the fabric via an adhesive in the adhesive layer.

In an embodiment of the clothing, the seam tape is positioned on an interior of the article of clothing.

In an embodiment of the clothing, the seam tape is positioned on a sewn seam of the article of clothing.

In an embodiment of the clothing, the seam tape further comprises an underlayment layer with the adhesive layer positioned between the top layer and the underlayment layer, and the underlayment layer is in contact with the fabric forming the clothing.

In an embodiment of the clothing, the wire comprises a metallic thread.

In an embodiment of the clothing, the wire comprises a metallized fiber.

In an embodiment of the clothing, the wire comprises an elongated strip of metalized fabric.

In an embodiment of the clothing, the elongated strip includes ends with a larger per unit area than a connection between the ends.

In an embodiment of the clothing, the top layer includes a hole therethrough so a portion of the metalized fabric is electrically accessible through the hole.

### BRIEF DESCRIPTION OF THE FIGURES

FIGS. 1A and 1B show a front angular perspective view of two embodiments of a seam tape including metalized fibers. In FIG. 1A the metalized fibers are in the adhesive layer while in FIG. 1B they are in an underlayment layer.

FIG. 2 shows a photograph of a seam tape including metalized fibers.

FIG. 3 shows a photograph of a seam tape including metalized fibers or fabric in place over a seam between two attached fabrics. The metalized components are not visible as they are hidden by the top layer of the seam tape.

FIG. 4 shows a photograph of an embodiment of a seam tape with metalized fabric wires placed therein. The top layer in this case is transparent.

FIG. 5 shows a photograph of an embodiment of a seam tape with metalized fabric wires and cutouts for connections in an opaque top layer.

FIG. 6 shows a similar embodiment to that of FIG. 5 but the top layer is transparent.

### DESCRIPTION OF PREFERRED EMBODIMENT(S)

As discussed herein, the terms “thread”, “yarn”, and “fiber” are often used interchangeably although those terms are often provided with specific meaning in the art. The reason for this is because the processes discussed herein can be used with any of these items. For the most part, however, this disclosure will generally attempt to use the terms as follows. A “filament” will be considered a single strand synthetic fiber or polymer extrusion or a single strand from a natural fiber (e.g. a single strand of cotton or hair of wool). Meanwhile a “yarn,” “thread,” or “filament bundle” is usually referring to a structure comprising a number of filaments combined together. For example, filaments which are spun or otherwise interconnected, entangled, or arranged together form a filament bundle or yarn. A thread herein may comprise, but is not limited to, staple, monofilament, spun yarn, co- or tri-extruded filaments of any geometry, microfiber, multifilament yarn, sewing yarn, or any other fiber used to connect one part of a piece of fabric with another. A “fiber” will generally be used to refer to both filaments and threads jointly.

Similarly, a “fabric” will generally be a plurality of filaments which are usually formed into yarns (although they may be used directly) and the yarns are then formed into a generally planar structure through weaving, sewing, darning, molding, or any other process known to those of ordinary skill in the art. Fabrics, will generally be combined with threads through sewing (although adhesives or other materials may be used in other cases) in order to turn the fabric into clothing.

When this disclosure is discussing the inclusion of metalized fibers in a fabric, metalized fibers themselves, or other metalized components of a fabric, the contemplation is generally that a metalized component be provided which meets certain electrical criteria and requirements regardless of how the metalized fiber doing the electrical transmission is actually constructed. In most cases, metalized fibers will comprise a natural or synthetic fiber either coated or impregnated with metallic particles to a sufficient degree to allow it to transmit an electrical impulse of size and duration sufficient for a prescribed task for which it is to be used without a loss which is not known and compensated for by the electrical communication protocol or other components in the circuit.

Exactly how such fiber is constructed or what it's capabilities are is generally not relevant to the present disclosure as the present disclosure is directed to how to mount a desired fiber and/or fabric that meets the necessary electrical criteria into a piece of clothing or onto a piece of fabric. However, it would be recognized by one of ordinary skill that fibers impregnated with metal will generally be more resilient to damage than those that are coated with metal and, therefore, the present disclosure will usually use as an example a fiber metalized by coating recognizing that the principle systems and methods discussed herein could also be applied to a fiber impregnated with metal.

In generating smart clothing, it is generally the case that the entire clothing article is not intended to be metalized in order to provide for electrical communication. Complete metallization will generally not work as the electrical communication cannot be easily carried from a distinct sensor to a distinct receipt point as there is no line of communication. Instead, the clothing will generally include a plurality of discrete “wires” within its fabric. These wires will generally be physically separate, insulated from each other, and will effectively act as wiring between distinct components such as, but not limited to, (micro)processors, sensors, and transceivers which will be located at different points in the clothing, or may be plugged into specific attachment points in the clothing.

The wires will carry a variety of electrical signals which can range from power transmission (generally in the firm of direct current (DC) transmission) to communication signals using any available wired electrical communication standard or method. The wires can comprise a number of different materials. In more traditional designs, the wire is often a single metalized fiber acting in the form of a single strand of metallic wire. For example, a fiber may be formed with a metallic wire core and/or multiple layers of metallization and/or insulation (including the filaments themselves) to act as a shielded or co-axial cable. Alternatively, fibers may be arranged together in the form of a twisted pair cable such as is used in category (e.g. CAT5, CAT6, or CAT7) cable to provide for data communication. Further, as discussed later in this disclosure, small strips of metalized fabric can be used as wires or arranged to be wires or form the components of wires.

Regardless of how the metalized fibers are arranged to form wires, metalized fibers will generally have some characteristics which are considered detrimental to their use in clothing. In particular, the primary problems contemplated by the systems and method herein are how to hide the wires from being externally visible on the clothing and how to protect the fibers from damage due to frictional wear and liquid (specifically water) exposure.

For this reason, the present application generally contemplates that protections for the metallization of the fiber will be supplied in the form of seam tape. Seam tape is a well-known structure used in the construction and repair of garments, and particularly waterproof and water resistant garments, to inhibit water passage through sewn seams of the garments or to repair rips or other damage. Seam tape in garment construction is commonly used in hard shell garments where the shell of the garment is made of a material which has generally been made to inhibit liquids (specifically liquid water) from passing through its structure. Seam tapes are generally known in the art and some examples are provide in U.S. Pat. Nos. 6,497,934 and 8,518,511 as well as PCT Patent Application Publication WO 91/07278. The entire disclosure of all these references is herein incorporated by reference.

Typically, seam tapes are used to cover a sewn seam of a garment. When two individual fabric pieces are joined (generally by sewing), the line of thread is usually covered by the seam tape by utilizing an adhesive layer of the seam tape to bond the tape to the area of the seam. The adhesive is often thermosetting, and heat is applied to the seam tape to bond the seam tape to the two pieces of fabric and seal in the thread and all associated needle holes. Thus, the resultant piece of clothing has a seam connecting two pieces of fabric, but the possible points of weakness from the sewing construction have been sealed by the tape. In the present case, seam tape is used as a methodology to provide for wiring in a garment to allow for electrical conductivity to occur. Generally, the wiring is provided by having individual or composite metalized fibers, threads, or fabrics be placed within or in contact with the adhesive of the seam tape.

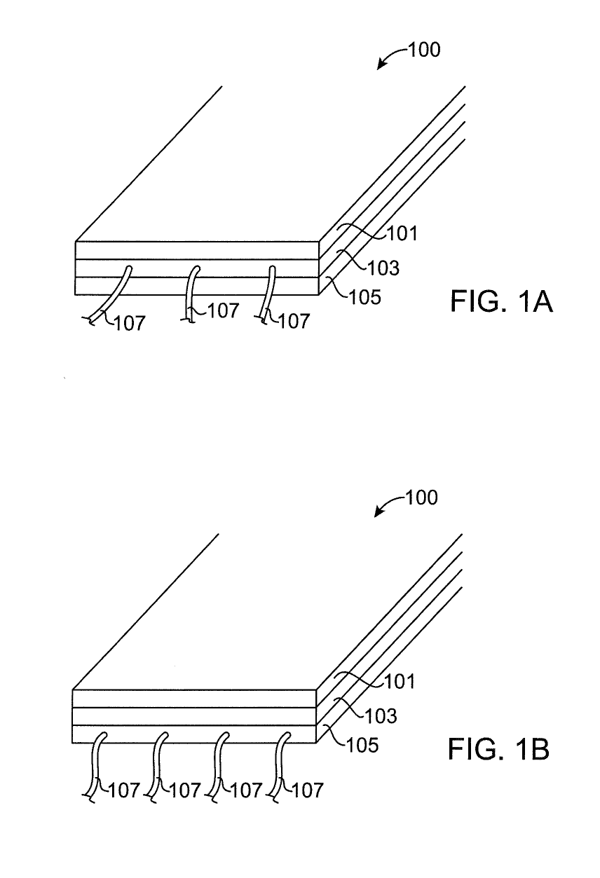

FIGS. 1A and 1B provide for embodiments of how a seam tape (100) can be used with metalized fibers and particularly threads or small thread structures. Seam tape (100) generally comprises a multi-layer structure with at least a top layer (101) which is chemically bonded to an adhesive layer (103). The top layer (101) is commonly fabric or other material used in garment construction such as vinyl or plastic sheeting. In many seam tapes (100) the top layer (101) is designed to be waterproof or highly water resistant. The adhesive layer (103) may be made up of any type of adhesive, but is often a thermosetting adhesive or sonically bonding adhesive which is chemically or otherwise bonded to the top layer (101) when the seam tape (100) is manufactured. In this way, the adhesive layer (103) and top layer (101) are generally inseparable from each other during normal installation and wear.

In the seam tapes (100) of FIGS. 1A and 1B, the tapes (100) include a third underlayment layer (105). This underlayment layer (105) is optional but is commonly used to provide additional wear resistance and transition with the fabrics to which the seam tape (100) is connected. The underlayment layer (105) will generally be designed so that the adhesive in the adhesive layer (103), when activated, can flow through the underlayment layer (105) and still bond with the underlying fabric of the clothing.

As can be seen in FIGS. 1A. and 1B, the wires (107) which will be used to carry electrical signals are generally embedded in the adhesive layer (103) as in FIG. 1A, or may be woven into the underlayment layer (105) as in FIG. 1B. The wires (107) will preferably be metalized fibers (107) either as threads or as thread constructs designed to form particular wire arrangements (e.g. co-axial or twisted pair arrangements). However, elongated metal structures, can be used in addition or instead of metalized fibers in different embodiments. These fibers (107) will generally comprise a natural or synthetic filament bundle which has been metalized with any metal of interest to make it electrically conductive.

In FIG. 1A, the fibers (107) are positioned in the adhesive layer (103). They will generally be placed within the adhesive when it is chemically bonded to the top layer (101). However, if the underlayment layer (105) is not present, the fibers (107) may actually be presented to the adhesive when the seam tape (100) is bonded to another piece of fabric. Specifically, the fibers (107) may be positioned on the underlying fabric or garment, the seam tape (100) may be placed thereon with the adhesive layer (103) in contact with the fibers (107). When the seam tape (100) is bonded to the garment or fabric in the traditional manner, the adhesive in the adhesive layer (103) will flow over the fibers (107) and contact the underlying fabric. Regardless of which of the above methods is used, it should be apparent that the fibers (107) will generally be encased within the adhesive layer (103) once the seam tape (100) is applied to a fabric or garment.

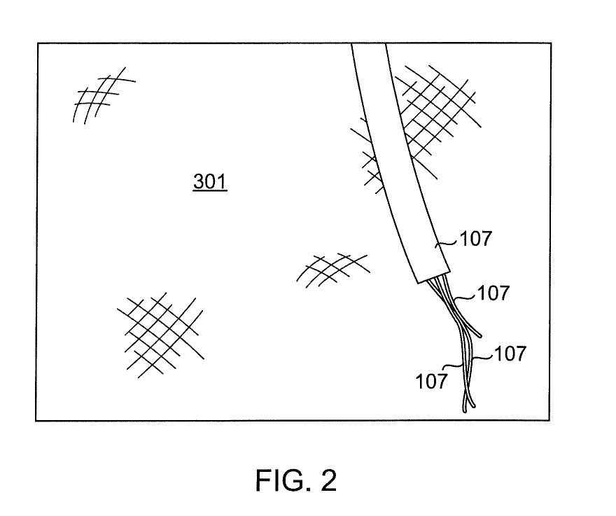

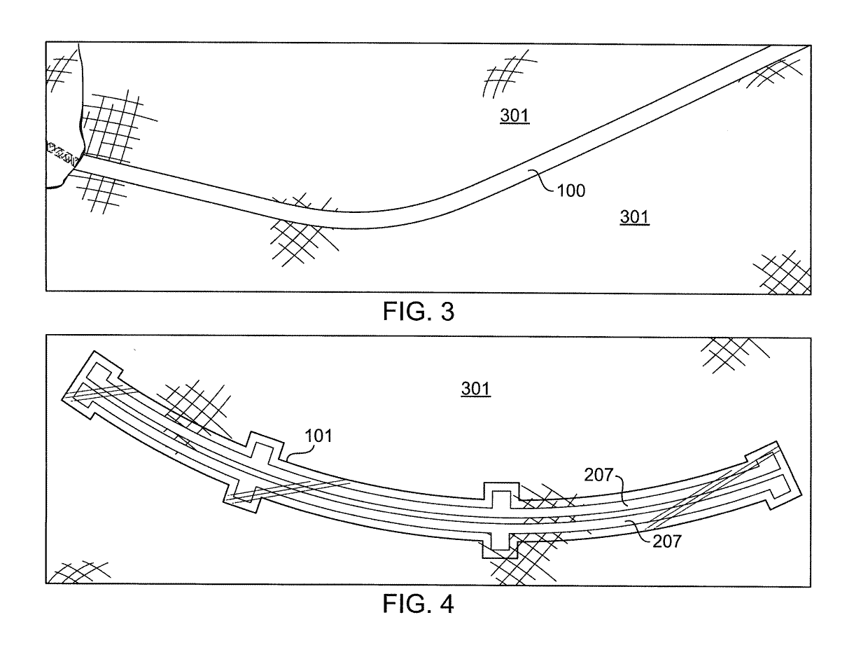

The structure of FIG. 1A where the metalized fiber or fibers (107) are in the adhesive layer (103) of the seam tape (100) after the seam tape (100) has been attached to the underlying fabric or garment should be readily apparent. In the first instance, the fibers (107) are not visible from either side of the garment. From the first side, they are blocked by the top layer, in the second they are blocked by the fabric of the garment. Thus, the fiber's (107) presence is not readily noticeable. This is shown, for example, in FIG. 2 where only exposed ends of the fiber (107) are visible and FIG. 3 where only the top layer (101) is visible.

By placing the metalized fibers (107) in the adhesive layer (103) of the seam tape (100), the adhesive can act as an insulator for the fibers (107) and they are also generally held in position relative to each other within the seam tape (100). Thus, electrical properties of the fibers (107) can be preserved. The seam tape (100), because it is also designed to be waterproof in most instances, also serves to protect the fibers (107) from degradation due to fluid contact. Specifically, the seam tape (100) (and underlying fabric) will resist penetration by fluid to get at the fibers (107) presuming the top layer (101), underlayment layer (105), or underlying fabric are considered waterproof. Further, the adhesive itself will generally also resist such penetration. Thus, the fiber (107) is generally protected from any form of contact with liquid water and associated degradation.

Generally, the fibers (107) will be allowed to extend beyond the ends of the seam tape (100) as indicated in FIGS. 1A and 1B but also shown in FIG. 2. The ends of the fibers (107) in this case can be used to make electrical connection with other components included in the garment. This can include, but is not limited to, sensors, processors, communication apparatus, power sources, and other wiring. How the wiring is hidden by the seam tape is best illustrated in FIG. 3.

While the above disclosure has focused on the use of individual metalized fibers (107) or wire-like metalized fiber structures made from specific fibers, FIGS. 4 through 6 provide for alternative embodiments of seam tape which utilize a “wire” which is a small generally planar construct of metalized fabric. In FIGS. 4 through 6, individual fibers (107) or thread structures are not used for conductivity. Instead, small strips of metalized fabric (207) which include a plurality of fibers are used. The metalized fabric (207) may be formed by any method known to those of ordinary skill, but will generally be mostly or completely metalized. Thus, the metalized fabric (207) can be formed from a plurality of metalized fibers (107) that are woven or otherwise connected together to form a fabric, or the metalized fabric (207) may be formed by other methods such as through the interknitting of metalized and non-metalized fibers of through metallization of a fabric in its finished constructed form.

The strips of fabric (207) generally comprise generally rectilinear structures with one dramatically elongated dimension. The elongation serves to provide the “run” of wire and for all intents and purposes the wire should be treated as an approximately planar strip of conductive material. These strips of metalized fabric (207) will also generally be positioned within the adhesive layer (103) of a seam tape (100) through any or all of the constructions contemplated for use with metalized fibers (107) above, and the seam tape (100) can be placed into a garment as discussed above in conjunction with individual fibers (107). Metalized fabrics (207) may also be formed into other specific wire-like structures in much the same manner as metalized fibers (107).

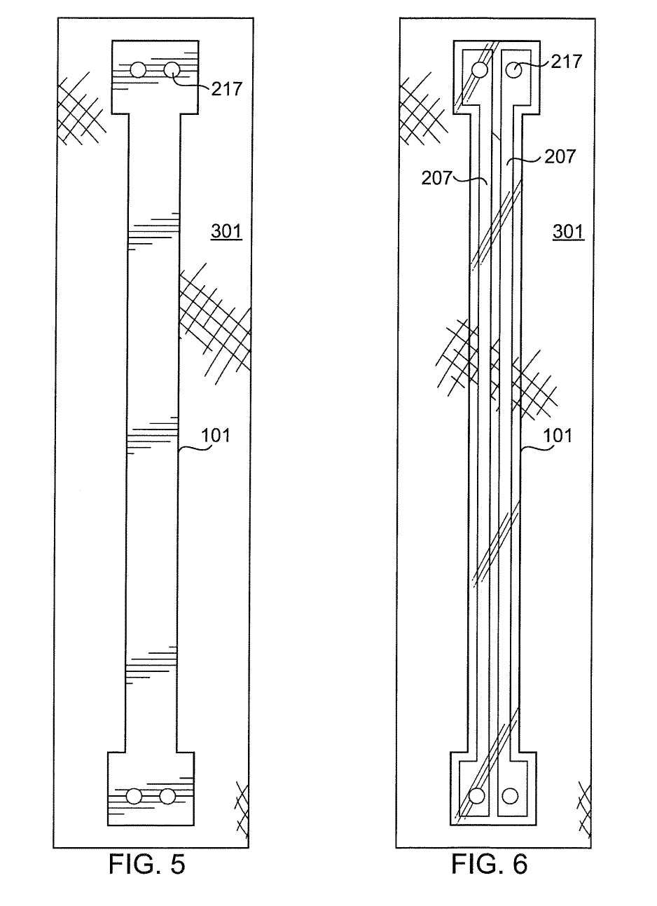

As can be best seen in FIGS. 5 and 6, an additional advantage of using metalized fabric (207) as the wire within a seam tape (100) is that the metalized fabric (207) can also directly provide sensor points. Depending on need and purpose, the metalized fabric (207) itself may be sufficient to detect electrical differences corresponding to desired physiological changes of the user. Alternatively, the metalized fabric (207) can directly provide a connection point for a sensor. Regardless, as can be seen in FIGS. 5 and 6, holes (217) can be cut in the top layer (101) to allow a small amount of the fabric (207) to be accessible through the top layer (101). These small spaces serve as sensor access points, sensors, or as connection points for other structures, such as batteries and processors. Specifically, they can provide a point of electrical connection through the top layer (101). As can be seen in FIGS. 5 and 6, the fabric (207) under the holes (217) may be of a generally larger per unit area than the fabric (207) forming the wires. This allows for a larger connection or sensor point, if desired.

It should be apparent from the above that placing either metalized fibers (107), or strips of metalized fabric (207), in or on the adhesive layer (103) or in the underlayment layer (105) of a seam tape (100) provides for many benefits in the wiring of clothing. In the first instance, many articles of clothing already utilize seam tapes as part of their construction for other reasons. In these types of clothing constructions, inclusion of the wiring in the seam tape provides for very little incremental change in the design of the clothing, while at the same time providing wiring over at least a portion of the clothing. Thus, placing the wires within the seam tapes which are already being used can provide for a large amount of wiring which has little to no effect on the feel of the clothing.

Further, the fibers (107) and fabrics (207) used herein are often no stiffer or less responsive than the seam tape (100) materials already are (once bonded). Thus, any change in feel is primarily due to the use of seam tape at all, and thus, the wiring inclusion provides for very little effect on feel. Further, because the top layer (101) can be opaque (and matched to the clothing) the wiring in the clothing can effectively be invisible as is it between the top layer (101) and the clothing (301) as best illustrated in FIG. 3.

The use of metalized fabrics (207) and fibers (107) will generally, however, not be limited to their inclusion as part of the installation of seam tapes (100) which are being installed for other reasons. This would limit the position of the wiring to existing seams and related structures, which, while it may serve to provide a communication backbone or wiring scheme in certain clothing and applications, does not necessarily work for a “last mile” connection to the individual sensors or other electronics in all cases.

The seam tape (100) structure, however, can still provide benefits to installation of wiring at any point in fabric as is best illustrated in FIGS. 5 and 6. Specifically, the seam tape (100) may be placed directly on any fabric surface (301) of the garment. Generally, this will be on an inner surface so that none of the top layer (101), the metalized fabric (207) of fiber (107), the adhesive layer (103), or the underlayment layer (105) is visible from the outside of the clothing.

As discussed above, the top layer (101) of the seam tape (100) is commonly a fabric, sheet plastic, or other structure. As such, a top layer (101) may also be provided with good feel against a user's skin when paired with the fabric (301) of the clothing or may have chemical agents that improve feel placed thereon. In this arrangement, The seam tape (100) need not be applied to a seam necessarily, but may be placed anywhere on any surface of the garment. This allows for the wiring to be positioned at virtually any location within the garment and it will appear as seam tape, not metalized wiring. Further, as the metalized fiber (107) or fabric (207) is not sewn into the garment, but is instead taped to the inside of it, the metalized fiber (107) or fabric (207) is generally not visible (unless it there is a hole (217) provided as contemplated elsewhere in this disclosure).

It should be recognized that for purposes of water protection of the metalized fiber (107) or fabric (207), the adhesive layer (103) and top layer (101) can only go so far as to provide waterproofing when the seam tape (100) is applied to a fabric surface (301) which is not waterproof as water could go through the surface (301). However, in such a scenario, the use of metalized fabric (207) as the wire as shown in FIGS. 4 through 6 can provide additional benefit over the use of individual metalized fibers (107). A metalized fabric (207) is generally a much more macro scale structure than an individual fiber (107) and will usually include a substantially greater amount of metal. Further, electric flow will generally only be interrupted if loss of metallization occurs at a point completely across the wire. With a metalized fabric (207) this requires a generally much larger loss of continuous metallization to create. Further, because the metalized fabric (207) can be metalized in a different fashion to an individual fiber (107) (for example it can be coated in metal after it is constructed), the metallization in fabric may be more resistant to damage from contact with liquids because the manner of metallization itself assists in resisting damage from exposure to liquids.

Thus, in an embodiment, the top layer (101) of the seam tape (100) and/or the clothing fabric (301), are not waterproofed at all. Instead, water contact is allowed to go through one or more of these structures and contact the metalized fabric (207) between. In this case, however, the contact may not be overly detrimental as the fabric (207) can accept much more laundering without losing sufficient electrical characteristics to be unviable. Thus, the fabric (207) arrangement of FIGS. 4 through 6 may be much more resistant to laundry damage than the single metalized fiber (107) structures of FIGS. 1A through 2.

Throughout this disclosure, relative terms such as “generally,” “about,” and “approximately” may be used, such as, but not necessarily limited to, with respect to shapes, sizes, dimensions, angles, and distances. One of ordinary skill will understand that, in the context of this disclosure, these terms are used to describe a recognizable attempt to conform a device to the qualified term. By way of example and not limitation, components such as surfaces described as being “generally parallel” will be recognized by one of ordinary skill in the art to not be, in a strict geometric sense, parallel, because, in a real world manufactured item, no surface is generally never truly planar as a “plane” is a purely geometric construct that does not actually exist, and no component is truly “planer” in the geometric sense. Thus, no two components of a real item are ever truly parallel, as they exist outside of perfect mathematical representation. Variations from geometric descriptions are inescapable due to, among other things: manufacturing tolerances resulting in shape variations, defects, and imperfections; non-uniform thermal expansion; design and manufacturing limitations, and natural wear.

There exists for every object a level of magnification at which geometric descriptors no longer apply due to the nature of matter. One of ordinary skill will understand how to apply relative terms such as “generally,” “about,” and “approximately” to describe a range of variations from the literal meaning of the qualified term in view of these and other considerations as well as that use of such mathematical terms is not intended to mean their strict mathematical relationship, but a general approximation of that relationship in the real world.

Further, use in this description of terms such as “forward” and “backward” do not actually require that certain surfaces or objects be closer or further away from a surface at any given time or to denote a necessary arrangement of components or components relative to a user. Instead, they are generally used to denote opposite directions in conjunction with the standard arrangement of the FIGS. provided herein so as to give relative positioning of elements. Similarly, terms such as “inside” and “outside”, “left” and “right”, and “top” and “bottom” are used to show relative directions or positions as opposed to absolute location relative any other component or a human user or observer.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A seam tape comprising:
a top layer;
an underlayment layer;
an adhesive layer arranged between said top layer and said underlayment layer; and
an electrically conductive wire, said wire being positioned within said adhesive layer and between said underlayment layer and said top layer;
wherein, said seam tape is configured to bond to a fabric placed proximate said underlayment layer via adhesive in said adhesive layer.

2. The seam tape of claim 1 wherein said wire comprises a metallic thread.

3. The seam tape of claim 1 wherein said wire comprises a metallized fiber.

4. The seam tape of claim 1 wherein said wire comprises an elongated strip of metalized fabric.

5. The seam tape of claim 4 wherein said elongated strip includes ends with a larger per unit area than a connection between said ends.

6. The seam tape of claim 5 wherein said top layer includes a hole therethrough so a portion of at least one of said ends is electrically accessible through said hole.

7. The seam tape of claim 4 wherein said top layer includes a hole therethrough so a portion of said metalized fabric is electrically accessible through said hole.

8. The seam tape of claim 1 wherein said adhesive is a thermosetting adhesive.

9. The seam tape of claim 1 wherein said adhesive is a sonic bonding adhesive.

10. The seam tape of claim 1 wherein said top layer is water resistant.

11. A seam tape comprising:
a top layer;
an adhesive layer arranged on said top layer; and
an electrically conductive wire, said wire being positioned within said adhesive layer;
wherein, said seam tape is configured to bond to a fabric placed proximate said adhesive layer via an adhesive in said adhesive layer.

12. An article of clothing comprising:
fabric forming said clothing; and
a seam tape including:
a top layer;
an adhesive layer arranged on said top layer; and
an electrically conductive wire, said wire being positioned within said adhesive layer;
wherein, said seam tape is bonded to said fabric via an adhesive in said adhesive layer.

13. The article of clothing of claim 12, wherein said seam tape is positioned on an interior of said article of clothing.

14. The article of clothing of claim 12, wherein said seam tape is positioned on a sewn seam of said article of clothing.

15. The article of clothing of claim 12, wherein said seam tape further comprises an underlayment layer with said adhesive layer positioned between said top layer and said underlayment layer, and said underlayment layer is in contact with said fabric forming said clothing.

16. The article of clothing of claim 12 wherein said wire comprises a metallic thread.

17. The article of clothing of claim 12 wherein said wire comprises a metallized fiber.

18. The article of clothing of claim 12 wherein said wire comprises an elongated strip of metalized fabric.

19. The article of clothing of claim 18 wherein said elongated strip includes ends with a larger per unit area than a connection between said ends.

20. The article of clothing of claim 18 wherein said top layer includes a hole therethrough so a portion of said metalized fabric is electrically accessible through said hole.
